(19) United States
(12) Patent Application Publication
(10) Pub. No.: US 2025/0083246 A1
(43) Pub. Date: Mar. 13, 2025

(54) ULTRACAPACITOR STUD WELDER

(71) Applicant: Autab, LLC, Vermilion, OH (US)

(72) Inventor: Jeffrey Krupp, Vermilion, OH (US)

(73) Assignee: Autab, LLC, Vermillion, OH (US)

(21) Appl. No.: 18/956,494

(22) Filed: Nov. 22, 2024

Related U.S. Application Data
(63) Continuation-in-part of application No. 17/204,632, filed on Mar. 17, 2021.
(60) Provisional application No. 62/993,330, filed on Mar. 23, 2020.

(51) Int. Cl. B23K 9/10; B23K 9/20

(52) U.S. Cl. CPC B23K 9/1006; B23K 9/1043; B23K 9/202

(57) ABSTRACT

Devices and systems are disclosed herein for drawn arc stud welding. These systems and devices allow welding operations while reducing the peak power draw of the input source, and include a charging circuit, an energy storage device comprising a plurality of low ESR ultracapacitors, and a discharge circuit.

### CLAIM OF PRIORITY

This application claims priority from and is a Continuation in Part of patent application Ser. No. 17/204,632, filed on Mar. 17, 2021, which in turn claims priority to Provisional Application Ser. No. 62/993,330 filed on Mar. 23, 2020, the entirety of each are incorporated by reference herein.

### BACKGROUND OF THE DISCLOSURE

The present disclosure generally relates to systems and devices used for stud welding, and more particularly to stud welding systems and devices, such as drawn arc welding tools.

Stud welding is a technique for welding a fastener, such as a stud or other fastener, to a parent metal of a workpiece. Various stud welding systems are known in the art for this purpose. One such type of stud welding system is known as a capacitive discharge (“CD”) system, which typically includes a charging circuit, an energy storage device, and a discharge circuit which extends through a weld stud gun. The power supply for such welding systems is normally an external source of AC power. In operation, the energy storage device is discharged to create an arc between a stud that is connected to the weld stud gun and the workpiece, thereby heating up the stud and the workpiece. When the arc is complete, the weld stud gun plunges the stud into the heated area on the workpiece to create a weldment. However, the capacitive discharge process that these systems use is recognized in the art and by key regulatory codes such as the American Welding Society (“AWS”) D1.1, as being unsuitable for full strength welds required in structural applications.

To produce full-strength welds suitable for structural applications, it is known in the art and required by AWS D1.1 welding code to apply a drawn arc stud welding system. A drawn arc stud welding system may include a high capacity electrical power converter, which may use a single phase or three phase industrial AC power supply as an input and may produce a high current DC welding output. For a drawn arc system capable of welding a stud of 2.54 cm (1 inch) diameter, this DC welding output current should be between 2000 and 2500 amps, for a duration of 1200 to 1600 milliseconds.

Typical drawn arc stud welding systems require a significant, abrupt power draw on the AC power supply because the idle power draw is minimal, but the weld draw is significant. This can cause large swings in voltage regulation when the AC power supply is a generator. As such, in prior art, the generator has to be oversized to overcome the abrupt load changes and peak power draw, resulting in a high cost initial purchase as well as high operating costs in diesel fuel.

Other energy storage stud welding devices store no or very little energy (e.g., about 7.5 kJ of energy) at a much higher (>200 VDC) bus voltage, which creates additional hazards for the operator.

Accordingly, there is a need in the art for a drawn arc stud welding system that provides improved management of the mains power by drawing steady power rather than abrupt pulses which overcomes the above mentioned deficiencies and others which provides better overall results.

Furthermore, prior art for stud welding at this power level often employs transformer-rectifier technology, which relies on heavy materials such as iron and copper. This results in an overall system weight of about 1000 lbs, making transportation challenging. By use of this art, ultracapacitors allow a reduction of weight by more than 50% for a system weight of 400-450 lbs, improving the ease of transportation and handling for the end user.

### SUMMARY OF THE DISCLOSURE

In accordance with one embodiment of this disclosure, described is a drawn arc fastener welding system comprising: a charging circuit; an energy storage device; and a discharge circuit. The charging circuit may be operatively connected to an external power supply and configured to generate a charging current. The energy storage device may be operatively connected to the charging circuit and be configured to (i) receive a charging current; and (ii) store a first amount(s) of energy for supporting at least one drawn arc stud welding operation; The discharge circuit may be operatively connected to the energy storage device and be configured to (i) receive an output current from the energy storage device; and (ii) communicate a discharge current to a drawn arc stud welding tool for a first time duration. In particular embodiments, the system may further comprise at least one of (i) the drawn arc stud welding tool; and (ii) the external power supply.

In further embodiments, the system may comprise a control system including: (i) at least one processor; (ii) a memory; and (iii) a user interface. The control system may be operatively connected to one or more of: the external power supply; the charging circuit; the energy storage device; the discharge circuit; and the drawn arc stud welding tool. The memory can be configured to store instructions to be executed by the at least one processor, and the user interface can be configured to enable multiple user-selectable modes of operation for the drawn arc fastener welding system.

In accordance with a second embodiment of this disclosure, described is a drawn arc stud welding system comprising: (i) a charging circuit; (ii) an energy storage device; (iii) a discharge circuit; (iv) a pilot arc circuit; (v) a constant current supply circuit; and (vi) an internal discharge circuit. The charging circuit can be operatively connected to an external power supply and configured to generate a charging current. The energy storage device can be operatively connected to the charging circuit and configured to (i) receive a charging current; and (ii) store a first amount(s) of energy for supporting at least one drawn arc stud welding operation. The discharge circuit can be operatively connected to the energy storage device and configured to: (i) receive an output current from the energy storage device; and (ii) communicate a discharge current to a drawn arc stud welding tool for a first time duration. The first time duration may be between about 5 ms to about 1500 ms, and will vary depend on the size of the stud to be welded. For example, the typical duration for a ¼″ diameter stud is about 250ms, 900 ms for a ¾″ diameter stud, and 1400 ms for a 1″ diameter stud.

The pilot arc circuit may be operatively connected to the charging circuit and configured to deliver an initial current to the drawn arc stud welding tool to support a pilot arc. The constant current supply circuit can be operatively connected to the energy storage device and configured to drive a weld tool solenoid. Finally, the internal discharge circuit may be operatively connected to the energy storage device and configured to reduce the energy stored in the energy storage device to near zero for the purpose of servicing the machine.

Stil other aspects of the disclosure will become apparent upon reading and understanding of the following detailed description.

### BRIEF DESCRIPTION OF THE DRAWINGS

The particular aspects and features discussed in the present disclosure can be varied and are referenced merely to illustrate one or more embodiments and are not intended to limit the scope thereof.

FIG. 1 is a block diagram of a drawn arc welding device illustrated in accordance with one aspect of the present disclosure.

FIG. 2 is a schematic diagram of a drawn arc welding device illustrated in accordance with another aspect of the present disclosure.

FIG. 3 is a first enlarged portion of the schematic diagram of a drawn arc welding device illustrated in accordance with one aspect of the present disclosure.

FIG. 4 is a second enlarged portion of the schematic diagram of a drawn arc welding device illustrated in accordance with one aspect of the present disclosure.

FIG. 5 is a third enlarged portion of the schematic diagram of a drawn arc welding device illustrated in accordance with one aspect of the present disclosure.

FIG. 6 is a fourth enlarged portion of the schematic diagram of a drawn arc welding device illustrated in accordance with one aspect of the present disclosure.

FIG. 7 is a fifth enlarged portion of the schematic diagram of a drawn arc welding device illustrated in accordance with one aspect of the present disclosure.

### DETAILED DESCRIPTION OF THE EMBODIMENTS

Various methods, apparatuses, devices, and systems are described herein which relate to drawn arc fastener welding. More specifically, the embodiments described herein relate to drawn arc fastener welding systems. The apparatuses, devices, and systems disclosed herein can deliver full strength stud welds for structural applications and have a form factor that allows a single user/operator to easily use and move.

Energy storage based, drawn arc stud welders are often powered from AC power outlets by grid or generator, typically at 230 VAC or 480 VAC. Energy storage devices of the present disclosure allow the devices and systems to display significantly improve capabilities over those devices and systems of the prior art. In particular, the energy density is significantly higher (i.e., about 40× that of traditional capacitors).

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s)”, “having,” “has,” “can,” “contain(s),” and variants thereof as used herein, are intended to be open-ended transitional phrases, terms, or words that require the presence of the named components and permit the presence of others.

Numerical values in the specification and claims of this application should be understood to include numerical values which are the same when reduced to the same number of significant figures and numerical values which differ from the stated value by less than the experimental error of conventional measurement techniques.

All ranges disclosed herein are inclusive of the recited endpoint and independently combinable (for example, the range “from 2 to 10” is inclusive of the endpoints, 2 and 10, and all the intermediate values).

The term “about” can be used to include any numerical value that can vary without changing the basic function of that value. When used with a range, “about” also discloses the range defined by the absolute values of the two endpoints, e.g., “about 2 to about 4” also discloses the range “from 2 to 4”. The term “about” may refer to plus or minus 10% of the indicated number.

As used herein, the term “drawn arc stud welding operation” refers to and means the process of welding a single stud fastener to a parent metal using a drawn arc welding process, which generally includes the steps of energizing a pilot arc current, lifting the weld stud off a workpiece and drawing the pilot arc, energizing a weld using a welding current for a specified amount of time, and plunging the weld stud into the workpiece.

As used herein, the terms “operatively connected” and “electrically connected” refer to and mean a component is connected to another component in such a manner so as to facilitate the transmission of electrical signals and/or electrical current.

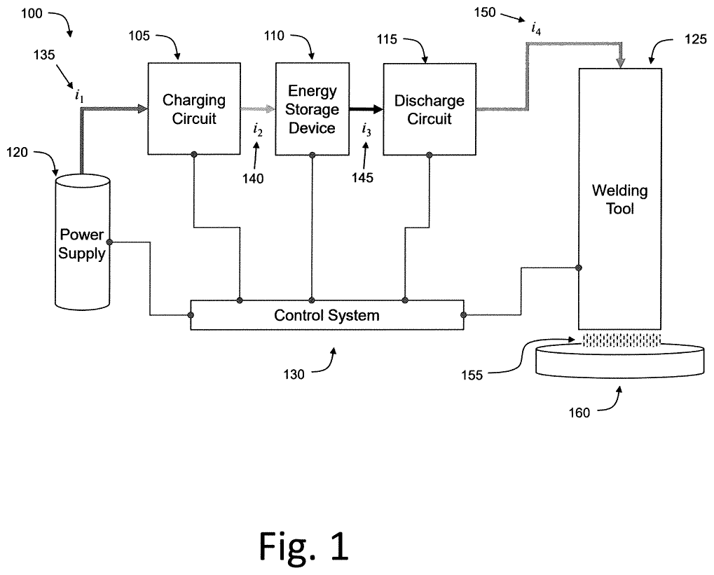

Referring now to the drawings, FIG. 1 illustrates a block diagram of a drawn arc fastener welding system 100 in accordance with one aspect of the present disclosure. The system includes at least a charging circuit 105, an energy storage device 110, and a discharge circuit 115. In further embodiments, the system 100 can also include an external power supply 120, a drawn arc stud welding tool 125, and/or a control system 130.

The charging circuit 105 can be operatively (e.g., electrically) connected to the energy storage device 110 and an external power supply 120. The energy storage device 110 can be operatively (e.g., electrically) connected to the charging circuit 105 and the discharge circuit 115. The discharge circuit can be operatively (e.g., electrically) connected to the energy storage device 110 and the welding tool 125. In particular embodiments, the control system 130 is operatively connected to one or more of: the charging circuit 105; the energy storage device 110; the discharge circuit 115; the power supply 120; and/or the welding tool 125.

The external power supply 120 can supply power to the system 100 by, for example, supplying a current i₁ 135 to at least the charging circuit 105. The charging circuit 105 may be configured to receive the current i₁ 135 and generate a charging circuit i₂ 140, which is communicated to the energy storage device 110. In other words, the charging circuit 105 regulates the charging of the energy storage device 110 by generating and providing a controlled current i₂ 140 to the energy storage device 110.

The energy storage device 110 can be configured to receive the charging current i₂ 140 and store at least a first amount of energy. The energy stored by the energy storage device 110 can be used to support one or more drawn arc stud welding operations, including a plurality of drawn arc stud welding operations.

The discharge circuit 115 can be configured to receive an output current i₃ 145 from the energy storage device 110 and generate a discharge current i₄ 150. When operatively connected to a welding tool 125, such as a stud fastener welding tool, the discharge circuit 115 communicates/delivers the discharge current i₄ 150 to the welding tool 125 for a first time duration. That is, the discharge circuit 115 delivers a discharge current i₄ 150 to the welding tool 125 for the requisite amount of time in order to: (i) generate an arc 155 between the fastener (not shown) and the parent metal 160; and (ii) complete a welding operation.

As mentioned above, the system 100 can include a control system 130 operatively connected to one or more of: the charging circuit 105; the energy storage device 110; the discharge circuit 115; the power supply 120; and/or the welding tool 125.

In particular embodiments, the control system 130 includes at least one processor; a memory configured to store instructions to be executed by the at least one processor; and a user interface configured to enable multiple user-selectable modes of operation for the drawn arc fastener welding system 100. For example, the control system 130 may be configured to: (i) monitor voltages in the energy storage device 110; (ii) protect the energy storage device 110 from overvoltage by balancing it with the discharge circuit(s) 115; (iii) control and coordinate all power supplies as the welding operation requires; (iv) monitor temperature within the energy storage device 110; and/or (v) monitor the health of the external power supply 120.

The memory of the control system 130 may represent any type of non-transitory computer readable medium such as random access memory (RAM), read only memory (ROM), magnetic disk or tape, optical disk, flash memory, or holographic memory. In one embodiment, the memory comprises a combination of random access memory and read only memory. In some embodiments, the processor and memory may be combined in a single chip. The memory of the control system 130 stores instructions for performing at least the steps described above, as well as the processed data, as necessary, such as any user-defined settings.

The digital processor of the control system 130 can be variously embodied, such as by a single-core processor, a dual-core processor (or more generally by a multiple-core processor), a digital processor and cooperating math coprocessor, a digital controller, or the like.

The term “instructions” as used herein is intended to encompass any collection or set of instructions executable by a computer or other digital system so as to configure the computer or other digital system to perform the task that is the intent of the software. Such instructions can be stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The software instructions of the control system 130 may include various components for implementing parts of the method. For example, the instructions of the control system 130 include components configured to: (i) monitor voltages in the energy storage device 110; (ii) protect the energy storage device 110 from overvoltage by balancing it with the discharge circuit(s) 115; (iii) control and coordinate all power supplies as the welding operation requires; (iv) monitor temperature within the energy storage device 110; and/or (v) monitor the health of the external power supply 120.

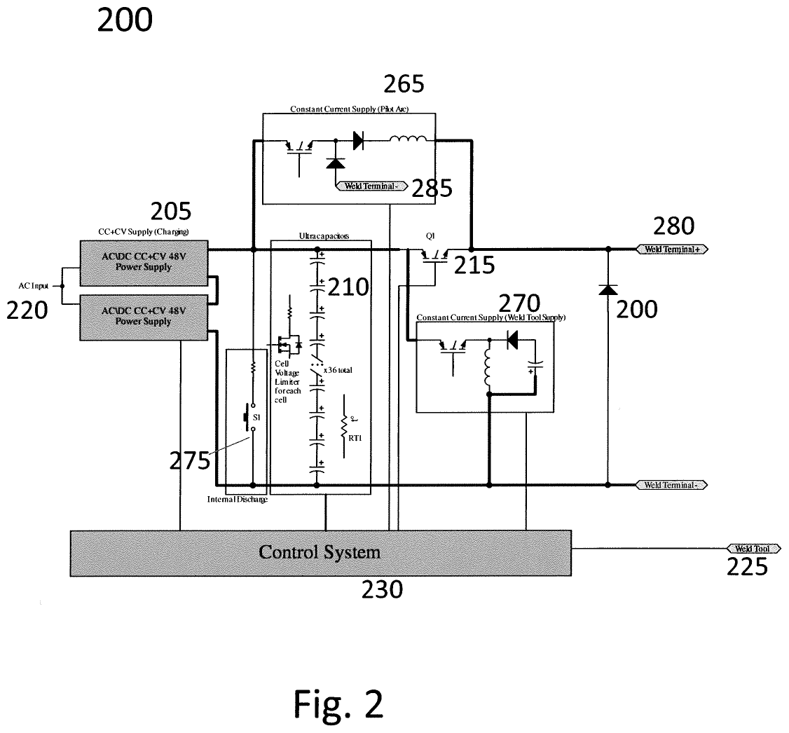

With reference to FIG. 2, a schematic of a drawn arc stud welding system 200 is illustrated in accordance with a second embodiment of the present disclosure is shown.

As is the case using a traditional stud welder, the operator loads a stud into a weld tool and pulls the trigger. This initiates the weld process that is entirely controlled by the welder's control system.

The stud welding process begins by starting the pilot arc. Then the control system energizes a solenoid within the weld tool, which lifts the stud off of the work piece drawing an arc. Following this, the main arc of user-configured current is turned on for a user-set duration as configured by the user interface. After the main current stage, the weld tool solenoid is de-energized and the stud plunges into the molten pool to make the weld.

Low ESR ultracapacitors are used to supply the high pulse needed for a stud weld; specifically (36+) series 3.0V cells with very low resistance, capable of 2400 A.

Power supplies are provided which are capable of constant current of 230 A between welds.

A control system is provided to monitor voltage on the ultracapacitor bank and control and coordinate all supplies as the process sequence requires and monitor temperature of ultracapacitor cells (RT1 in schematic).

A chopper constant-current switching (150 KHz+) supply regulates charging of the ultracapacitors.

A chopper constant-current switching (150 kHz+) supply delivers the pilot arc.

A chopper constant-current main discharge circuit (q1) delivers up to 2400 ADC during a weld.

A buck-boost supply charges a separate capacitor to 100 VDC for driving a weld tool solenoid.

An internal discharge path to the ultracapacitor bank is used for serviceability and dissipates the energy from the ultracapacitors when service is required

This embodiment draws a relatively constant power on the AC supply, making generator applications much more efficient for a lower cost of ownership than anything available on the market to date. Further, it minimizes the weight by about 60% of current day solutions.

Here, the drawn arc stud welding system 200 includes: (i) a charging circuit 205; (ii) an energy storage device 210; (iii) a discharge circuit 215; (iv) a pilot arc circuit 265; (v) a constant current supply circuit 270; and (vi) an internal discharge circuit 275. As illustrated, the system 200 can also include an external power supply 220, such as a generator, and a control system 230. The system 200 may further include a welding tool 225, such as a stud gun, having a positive terminal 280 and a negative terminal 285.

As an alternative a generator may be used for providing the charging current 205. That is, the functions of the charging current 205 are built into the generator.

As seen in FIG. 2, the charging circuit 205 can be operatively connected to the external power supply 220 and the energy storage device 210; the energy storage device 210 can be operatively connected to the charging circuit 205 and the discharge circuit 215; and the discharge circuit 215 can be operatively connected to the energy storage device 210 and the drawn arc stud welding tool 225, for example, via the negative terminal 285. Further, the pilot arc circuit 265 can be operatively connected to the charging circuit 205. The constant current supply circuit 270 can be operatively connected to the energy storage device 210 and the weld tool 225 (e.g., via terminal 285). And the internal discharge circuit 275 can be operatively connected to the energy storage device 210 and the weld tool 225 (e.g., via terminal 285).

In particular embodiments, the system 200 can include a control system 230, which may be operatively connected to one or more of: the charging circuit 205; the energy storage device 210; the discharge circuit 215; the power supply 220; the pilot arc circuit 265; the constant current supply circuit 270; and/or the weld tool 225.

The discharge circuit 215 can be, for example, a chopper constant-current discharge circuit configured to deliver up to about 2400 ADC for a period of time (i.e., during a welding operation). The discharge circuit 215 can include at least a transistor to regulate a constant discharge current, which may be operatively connected to the control system 230.

In certain embodiments, the power supply 220 may be a generator. In some embodiments, the power supply 220 may be grid power.

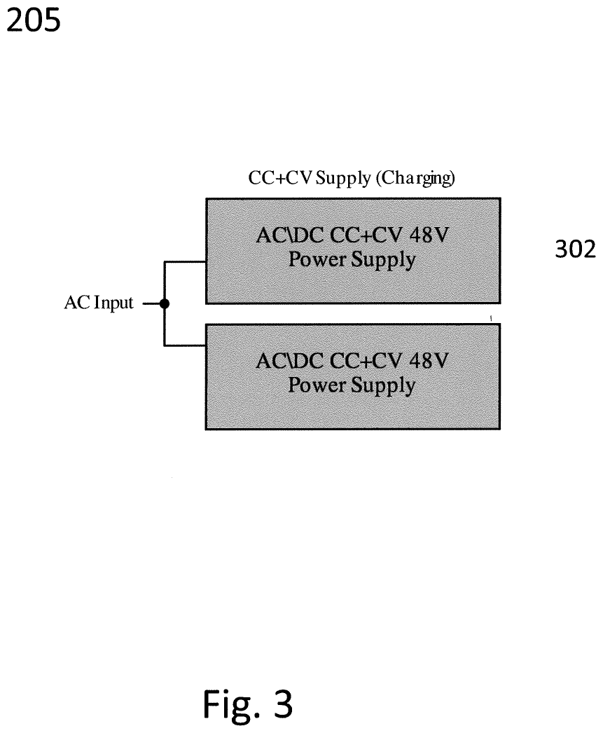

The charging circuit 205 may be a chopper constant-current switching supply configured to regulate the charging of the energy storage device 210. In some embodiments, the charging circuit 205 has a switching frequency of at least 150 kHz, or about 150 KHz. As shown in FIG. 3, the charging circuit 205 can comprise constant current AC\DC power supplies.

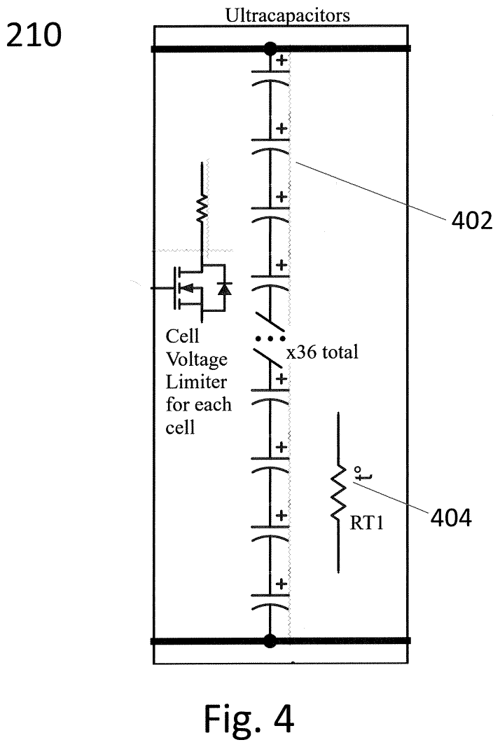

Turning to FIG. 4, the energy storage device 210 may comprise a plurality of capacitors 402, including at least about 32 capacitors 402, or between about 32 and about 54 capacitors, or about 16 capacitors 402. Each of the capacitors 402 may be operatively connected in series. In certain embodiments, the capacitors 402 may be polarized capacitors 402 and/or low equivalent series resistance (“ESR”) capacitors 402. In further embodiments, each of these capacitors 402 may be an ultracapacitor, such as a 3.0V ultracapacitor cell. As described above, these capacitors 402 may be configured to store sufficient energy to support at least one drawn arc stud welding operation. For example, the energy storage device 210 may store at least about 800 kJ of energy, or at least about 1 MJ, or between about 800 kJ to about 1.6 MJ, or about 1.4 MJ. Accordingly, the energy storage devices 210 of the present disclosure are capable of providing a high-power pulse needed for a stud weld operation.

In particular embodiments, the energy storage device 210 further comprises one or more temperature sensors 404 operatively connected to the control system 230. These temperature sensors 404 can be used by the control system 230 to monitor the temperature of the ultracapacitor cells 402.

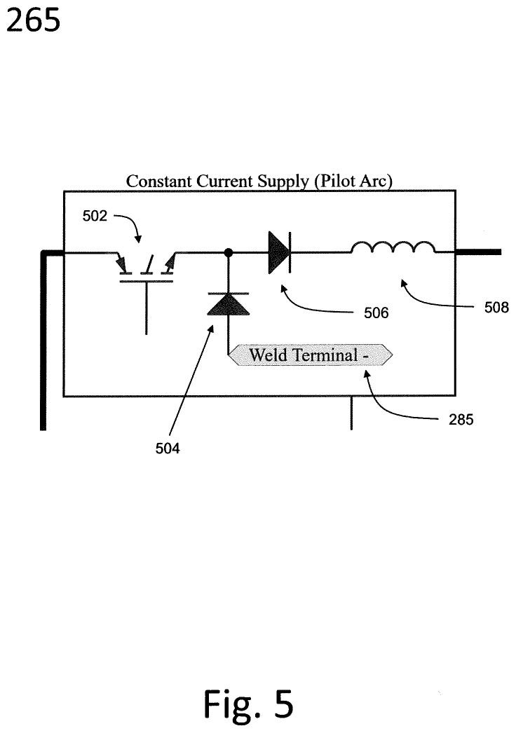

Turning to FIG. 5, the pilot arc circuit 265 may be a chopper constant-current switching supply configured to deliver a pilot arc via the weld tool 225, 285. In some embodiments, the pilot arc circuit 265 has a switching frequency of at least 150 kHz, or about 150 KHz. As seen in FIG. 5, the pilot arc circuit 265 may include a transistor 502, one or more rectifier diodes 504, 506, and an inductor 508. Further, the pilot arc circuit 265 may be operatively connected to the weld tool 225, for example, via the negative terminal 285 of the weld tool 225.

In certain embodiments, the system 200 includes an internal discharge circuit 275, which can be configured to dissipate energy from the ultracapacitors when service of the system 200 is required.

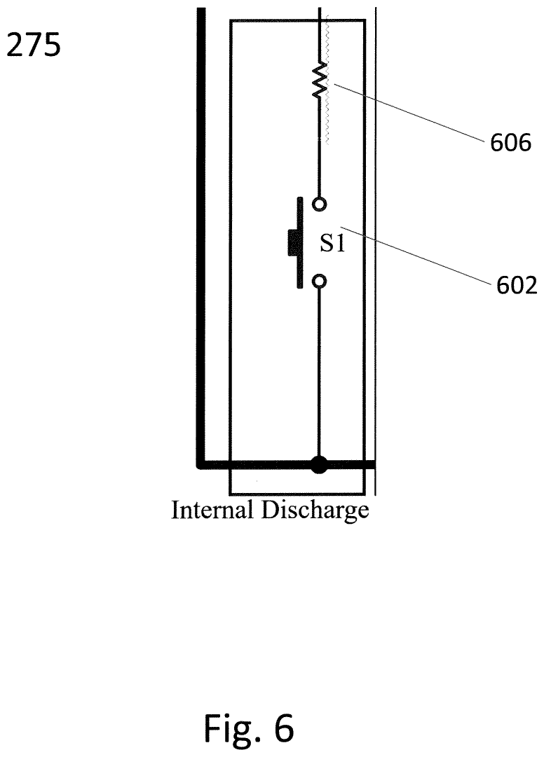

As shown in FIG. 6, the system 200 can include an internal discharge circuit 275 configured to reduce the energy stored in the energy storage device 210 to zero or about zero. The internal discharge circuit 275 may include a push-button switch 602 and one or more resistors 606.

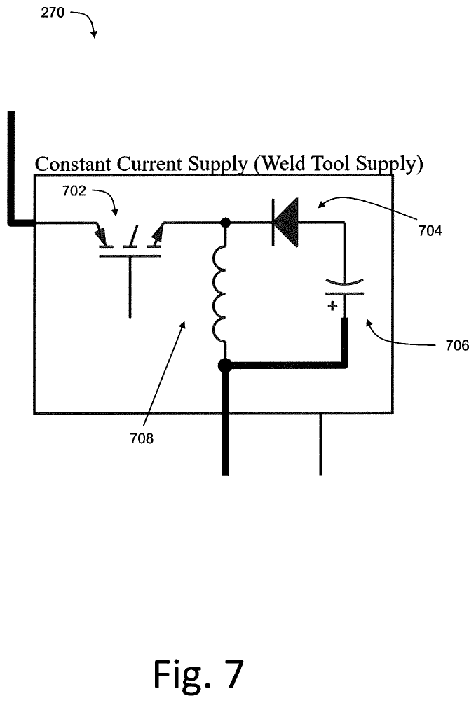

Turning to FIG. 7, the system 200 can include a separate constant current supply circuit 270. The constant current supply circuit 270 may be configured to separately provide energy to the weld tool 225. For example, in particular embodiments, the constant current supply circuit 270 may be configured to drive the operation of a solenoid (not shown) of the weld tool 225. The solenoid of the weld tool 225 is used to control the position of the stud/fastener that is to be welded to the parent metal. In some embodiments, the constant current supply circuit 270 may be a buck-boost supply configured to charge a separate capacitor to about 100 VDC for driving the weld tool solenoid. As illustrated in FIG. 7, the constant current supply circuit 270 can include a transistor 702, a rectifier diode 704, a capacitor 706, and an inductor 708.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

What is claimed is:

1. A drawn arc fastener welding system comprising:
a charging circuit operatively connected to an external power supply and configured to generate a charging current;
an energy storage device operatively connected to the charging circuit, wherein the energy storage device is configured to receive the charging current and to store a first amount of energy for supporting at least one drawn arc stud welding operation; and
a discharge circuit operatively connected to the energy storage device, wherein the discharge circuit is configured to receive an output current from the energy storage device and communicate a discharge current to a drawn arc stud welding tool for a first time duration.

2. The drawn arc fastener welding system of claim 1, wherein the system further comprises the drawn arc stud welding tool, the welding tool being configured to receive one or more welding fasteners and being operatively connected to at least the discharge circuit.

3. The drawn arc fastener welding system of claim 2, wherein the system further includes:
a control system operatively connected to one or more of: the external power supply; the charging circuit; the energy storage device; the discharge circuit; and the drawn arc stud welding tool;
wherein the control system comprises:
at least one processor;
a memory configured to store instructions to be executed by the at least one processor; and
a user interface configured to enable multiple user-selectable modes of operation for the drawn arc fastener welding system.

4. The drawn arc fastener welding system of claim 3, wherein the system further comprises the external power supply.

5. The drawn arc fastener welding system of claim 4, wherein the external power supply is a generator or grid power.

6. The drawn arc fastener welding system of claim 5, wherein the external power supply has a voltage of about 230V and a current of about 225 A.

7. The drawn arc fastener welding system of claim 1, wherein the energy storage device comprises a plurality of capacitors in series.

8. The drawn arc fastener welding system of claim 7, wherein each capacitor of the plurality of capacitors is a low equivalent series resistance (ESR) capacitor.

9. The drawn arc fastener welding system of claim 1, wherein the charging circuit is a chopper constant-current switching supply circuit configured to regulate the charging of the energy storage device.

10. The drawn arc fastener welding system of claim 1, wherein the discharge circuit is a chopper constant-current discharge circuit configured to communicate the discharge current to the drawn arc stud welding tool for the first time duration.

11. The drawn arc fastener welding system of claim 1, wherein the discharge current communicated to the drawn arc stud welding tool is up to 2400 ADC.

12. A drawn arc stud welding system comprising:
a charging circuit operatively connected to an external power supply and configured to generate a charging current;
an energy storage device operatively connected to the charging circuit, wherein the energy storage device is configured to receive the charging current and store a first amount of energy for supporting at least one drawn arc stud welding operation;
a discharge circuit operatively connected to the energy storage device, wherein the discharge circuit is configured to receive an output current from the energy storage device and communicate a discharge current to a drawn arc stud welding tool for a first time duration;
a pilot arc circuit operatively connected to the charging circuit and configured to deliver an initial current to the drawn arc stud welding tool to support a pilot arc;
a constant current supply circuit operatively connected to the energy storage device and configured to drive a weld tool solenoid; and
an internal discharge circuit operatively connected to the energy storage device.

13. The drawn arc stud welding system of claim 12, wherein the system further comprises a control system operatively connected to at least one of:
the external power supply; the charging circuit; the energy storage device; the discharge circuit; the pilot arc circuit; and the constant current supply circuit;
wherein the control system comprises:
at least one processor;
a memory configured to store instructions to be executed by the at least one processor; and
a user interface configured to enable multiple user-selectable modes of operation for the drawn arc fastener welding system.
